(19) United States
(12) Patent Application Publication
(10) Pub. No.: US 2015/0379700 A1
(43) Pub. Date: Dec. 31, 2015

(54) ULTRASOUND IMAGE DISPLAYING APPARATUS AND METHOD FOR DISPLAYING ULTRASOUND IMAGE

(71) Applicant: GE MEDICAL SYSTEMS GLOBAL TECHNOLOGY COMPANY, LLC, Waukesha, WI (US)

(72) Inventors: Naohisa KAMIYAMA, Tokyo (JP); Hiroshi HASHIMOTO, Tokyo (JP)

(73) Assignee: GE Healthcare Japan Corporation, Tokyo (JP)

(21) Appl. No.: 14/767,256

(22) PCT Filed: Feb. 12, 2014
(86) PCT No.: PCT/US2014/016075

§ 371 Date: Aug. 11, 2015

(30) Foreign Application Priority Data
Feb. 13, 2013 (JP) 2013-025316

(51) Int. Cl. G06T 5/50; G06T 7/00; G06T 7/20

(52) U.S. Cl. CPC G06T 5/50; G06T 7/20; G06T 7/0012; G06T 2207/10132; G06T 2207/30104

(57) ABSTRACT

An ultrasound image displaying apparatus includes: a composite data generating unit which generates composite data in which data based on echo signals obtained by transmitting ultrasound to a subject are multiple-frame combined; a display unit on which an ultrasound image based on the composite data is displayed; and an index calculating unit which calculates an index related to the amount of motion artifacts in the ultrasound image for each frame, based on the data. The composite data generating unit generates composite data combined using data of some or all frames in each of which the index satisfies a prescribed reference.

### TECHNICAL FIELD

Embodiments of the present invention relate to an ultrasound image displaying apparatus which generates composite data in which data based on echo signals obtained by transmitting ultrasound to a subject are combined over multiple frames, and a method for displaying an ultrasound image thereof.

### BACKGROUND ART

For example, when one intends to observe a blood flow in an ultrasound image, the blood flow may be extracted only in a limited way within an ultrasound image of one frame, depending on the position of a transmission/reception surface of ultrasound and imaging timing. There has therefore been disclosed in, for example, a Patent Document 1, an ultrasound diagnostic apparatus which generates composite data in which data based on echo signals are multiple-frame combined, and displays an ultrasound image based on the composite data.

The composite data is comprised of, for example, data indicative of the maximum brightness, of data of plural frames. The data of the plural frames are a data group (Volume Data) obtained at a plurality of positions in a three-dimensional region of a subject, or data different in time obtained with respect to one cross section of the subject. Combining such data of plural frames together enables grasping of a vascular structure that cannot be obtained with the ultrasound image of one frame.

The Patent Document 1 discussed above is Japanese Patent No. 3365929.

Meanwhile in an ultrasound image, noise called motion artifacts may occur due to the pulsation of blood vessels, body motion and the like. If such noise is included in combined data even one frame, an ultrasound image displayed based on the composite data leads to an image of image quality difficult to grasp a vascular structure.

### SUMMARY

An embodiment of the present invention provides an ultrasound image displaying apparatus which is equipped with a composite data generating unit which generates composite data in which data based on echo signals obtained by transmitting ultrasound to a subject are multiple-frame combined, a display unit on which an ultrasound image based on the composite data is displayed, and an index calculating unit which calculates an index related to the amount of motion artifacts in the ultrasound image for each frame, based on the data, and in which the composite data generating unit generates composite data combined using data of some or all frames in each of which the index satisfies a prescribed reference.

Further, an embodiment of the present invention provides an ultrasound image displaying apparatus equipped with an operation unit which sets the prescribed reference through an operator.

According to embodiments of the present invention, the composite data combined using the data of some or all frames in each of which the index related to the amount of the motion artifacts satisfies the prescribed reference is obtained, thus making it possible to display an ultrasound image of desired image quality in terms of the motion artifacts.

Further, according to embodiments of the present invention, the prescribed reference can be set by the operation unit in such a manner that the operator is able to display an ultrasound image of desired image quality.

Further objects and advantages of the present invention will be apparent from the following description of the embodiments of the invention as illustrated in the accompanying drawings.

### BRIEF DESCRIPTION OF DRAWINGS

FIG. 1 is a block diagram showing one example of a schematic configuration of an ultrasound diagnostic apparatus according to an embodiment of the invention.

FIG. 2 is a block diagram illustrating a configuration of a display controller of the ultrasound diagnostic apparatus shown in FIG. 1.

FIG. 3 is a diagram showing an ultrasound image displayed on a display unit.

FIG. 4 is a flowchart depicting the operation of one example illustrative of the embodiment of the ultrasound diagnostic apparatus according to an embodiment of the invention.

FIG. 5 is a diagram showing the display unit to which a region of interest for index calculation is set in the ultrasound image.

FIG. 6 is a diagram for describing that a maximum intensity projection is performed exclusive of color Doppler image data of indexes greater than a threshold value.

FIG. 7 is a diagram for describing the setting of a threshold value.

### DESCRIPTION OF EMBODIMENTS

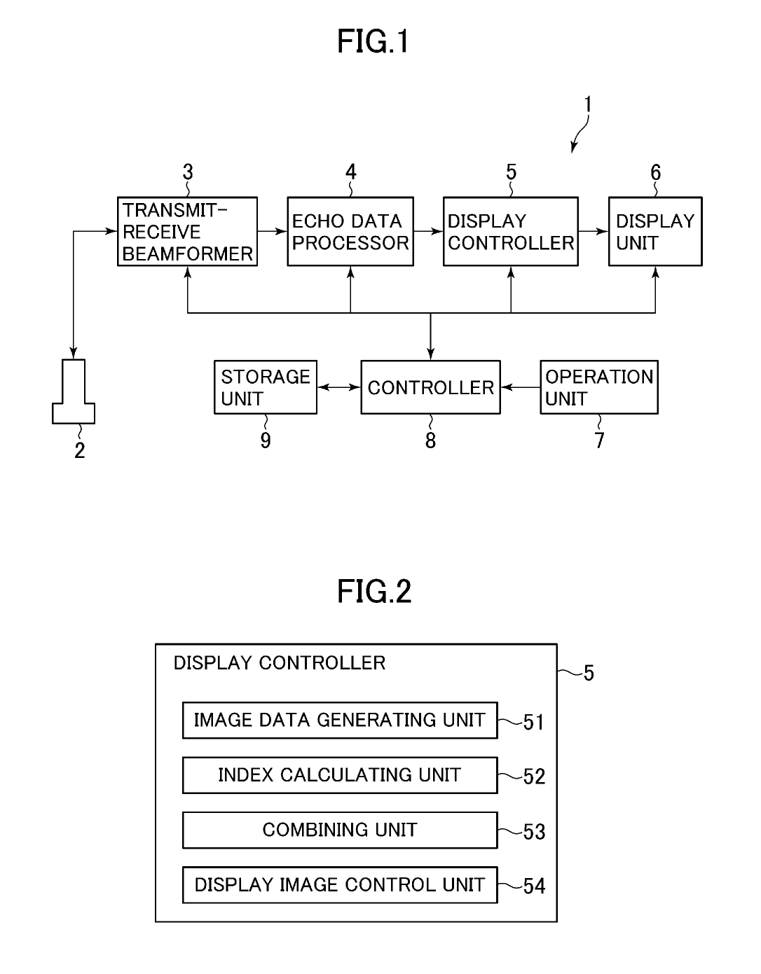

An embodiment of the invention will hereinafter be described in detail based on FIGS. 1 through 7. An ultrasound diagnostic apparatus 1 shown in FIG. 1 is equipped with an ultrasound probe 2, a transmit-receive beamformer 3, an echo data processor 4, a display controller 5, a display unit 6, an operation unit 7, a controller 8 and a storage unit 9. The ultrasound diagnostic apparatus 1 displays an ultrasound image on the display unit 6. Therefore, the ultrasound diagnostic apparatus includes an ultrasound image displaying apparatus.

The ultrasound probe 2 is comprised of a plurality of ultrasound transducers (not shown) arranged in array form. The ultrasound probe 2 transmits ultrasound to a subject through the ultrasound transducers and receives its echo signals therein.

The transmit-receive beamformer 3 supplies an electric signal for transmitting ultrasound from the ultrasound probe 2 under a predetermined scan condition to the ultrasound probe 2, based on a control signal outputted from the controller 8. Also, the transmit-receive beamformer 3 performs signal processing such as A/D conversion, phasing-adding processing and the like on each echo signal received by the ultrasound probe 2 and outputs echo data subsequent to the signal processing to the echo data processor 4.

The echo data processor 4 performs signal processing or the like for generating an ultrasound image on the echo data outputted from the transmit-receive beamformer 3. For example, the echo data processor 4 performs B-mode processing. Also, the echo data processor 4 performs color Doppler processing as processing for obtaining data indicative of the motion of tissues such as a blood flow in the subject in addition to the B-mode processing.

Here, the tissue motion also includes the motion of biological tissues due to the pulsation of blood vessels, body motion and the like that become a cause of motion artifacts.

The B-mode processing includes logarithmic compression processing, envelop detection processing, etc. B-mode data is generated by the B-mode processing.

The color Doppler processing includes quadrature detection processing, MTI (Moving Target Indication filter) processing, autocorrelation arithmetic processing, etc. Color Doppler data is generated by the color Doppler processing.

The display controller 5 has an image data generating unit 51, an index calculating unit 52, a combining unit 53, and a display image control unit 54 as shown in FIG. 2. The image data generating unit 51 scan-converts the B-mode data by a scan converter to generate B-mode image data. Also, the image data generating unit 51 scan-converts the color Doppler data to generate color Doppler image data.

The index calculating unit 52 calculates an index related to the amount of motion artifacts for each frame, based on the color Doppler image data. The details thereof will be described later.

The combining unit 53 performs a composite data generating function. Specifically, the combining unit 53 combines the B-mode image data of one frame and the color Doppler image data of one frame together to generate first composite image data of one frame. Also, the combining unit 53 combines the color Doppler image data of plural frames together to generate composite color Doppler image data of one frame. Further, the combining unit 53 combines the composite color Doppler image data of one frame and the B-mode image data of one frame together to generate second composite image data of one frame.

The combining unit 53 combines color Doppler image data of frames in which the index satisfies a prescribed reference. The prescribed reference is set in such a manner that an ultrasound image (color Doppler image) of desired image quality can be obtained. The details thereof will be described later.

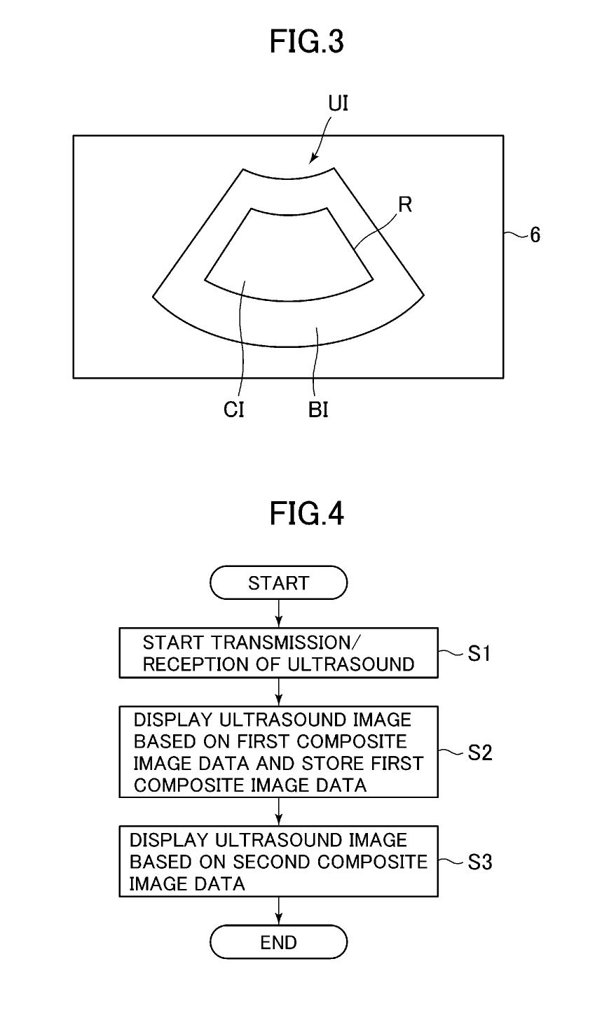

The display image control unit 54 causes the display unit 6 to display an ultrasound image UI in which a color Doppler image CI is overlaid on a B-mode image BI, as shown in FIG. 3 (display image control function). The color Doppler image CI is displayed in a region of interest R set to the B-mode image BI.

The display unit 6 is comprised of an LCD (Liquid Crystal Display), a CRT (Cathode Ray Tube) or the like. Although not illustrated in particular, the operation unit 7 includes a keyboard, a dial and a pointing device or the like for inputting instructions and information by an operator.

The controller 8 is a CPU (Central Processing Unit). The controller 8 reads a control program stored in the storage unit 9 to execute functions at the respective parts of the ultrasound diagnostic apparatus 1 in addition to the index calculating function, the composite data generating function and the display image control function.

The storage unit 9 is, for example, an HDD (Hard Disk Drive) or a semiconductor memory or the like.

The operation of the ultrasound diagnostic apparatus 1 according to the present embodiment will now be described based on the flowchart of FIG. 4. First, at Step S1, the operator starts transmission/reception of ultrasound to and from the subject by the ultrasound probe 2 and obtains echo signals. The operator may move the ultrasound probe 2 on the body surface of the subject to obtain echo signals (volume data) of plural frames in a three-dimensional region. Also, the operator may obtain echo signals of plural frames different in time with respect to one cross section of the subject.

Next, at Step S2, the combining unit 53 generates the first composite image data, based on B-mode image data and color Doppler image data generated on the basis of the echo signals obtained by the transmission/reception of the ultrasound. Then, the display image control unit 54 causes the display unit 6 to display an ultrasound image UI in which a color Doppler image CI is overlaid on a B-mode image BI, based on the first composite image data.

The B-mode image data, the color Doppler image data and the first composite image data are stored in the storage unit 9.

Next, at Step S3, the operator causes an ultrasound image UI based on the second composite image data to be displayed. When the operator performs the input of displaying the ultrasound image UI based on the second composite image data using the operation unit 7, the combining unit 53 generates composite color Doppler image data, based on the color Doppler image data stored in the storage unit 9. Then, the combining unit 53 combines the color Doppler image data and B-mode image data to generate the second composite image data.

A description will be made of the generation of the composite color Doppler image data. The index calculating unit 52 calculates an index related to the amount of motion artifacts with respect to the color Doppler image data of each frame. This index is an index indicative of the degree of existence of motion artifacts in the color Doppler image.

Now, if the motion artifacts increase in the ultrasound image indicative of the motion of each tissue in the subject, such as the color Doppler image, the volume of data indicative of the motion of each tissue in the subject, obtained based on echo signals of one frame. Thus, in the present embodiment, an index related to the volume of data indicative of the motion of the tissue in the subject, obtained based on the echo signals of one frame is defined to be the above index. The color Doppler image data is of data indicative of the motion of the tissue in the subject. Accordingly, the index calculating unit 52 calculates the rate of color Doppler image data existing in a region of interest r for index calculation set to the color Doppler image CI as the index as shown in FIG. 5.

Specifically, assuming that the number of all pixels in the region of interest r for the index calculation is P1 and the number of pixels (pixels by which a color Doppler image is represented) in which color Doppler image data exists is P2, an index IN is calculated by the following equation (1):

IN=P2/P1 (1)

The index IN calculated by the above equation (1) becomes a large value as the motion artifacts increase.

The combining unit 53 performs MIP (Maximum Intensity Projection) on color Doppler image data of plural frames to generate the composite color Doppler image data. That is, the combining unit 53 selects the maximum data values out of the color Doppler image data of the plural frames at a spatially corresponding pixels and thereby generates the composite color Doppler image data of one frame.

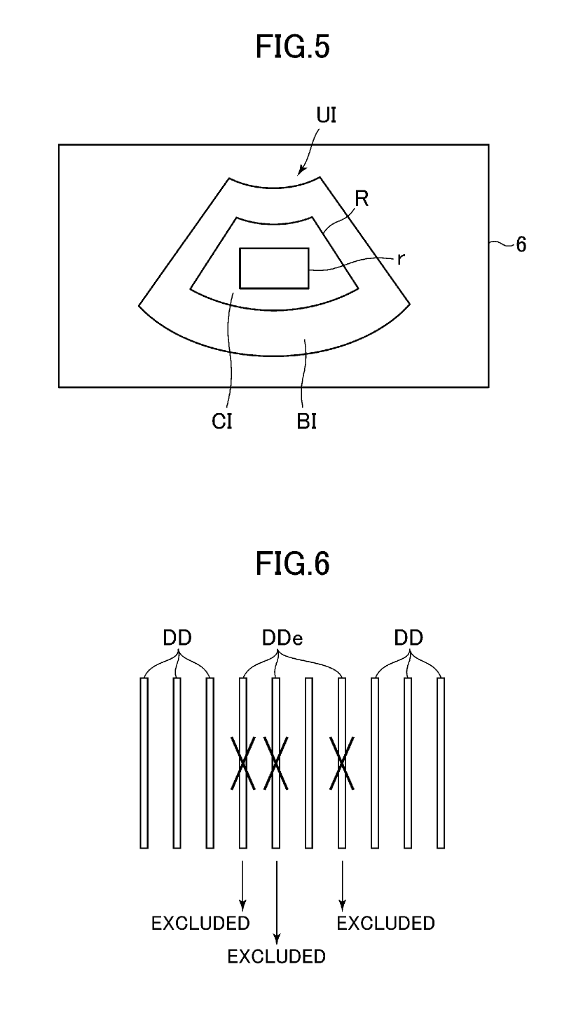

As shown in FIG. 6, however, the combining unit 53 performs the maximum intensity projection with the exception of color Doppler image data DDe at which the index IN is greater than or equal to a threshold value INth, of color Doppler image data DD of plural frames. That is, in the present embodiment, the composite color Doppler image data is generated using the data (data of maximum values) of some frames in which the index IN satisfies the prescribed reference, of the color Doppler image data DD of the plural frames.

The threshold value INth is set by the input of the operation unit 7 by the operator. For example, the threshold value INth may be made settable to a desired value by turning the dial of the operation unit 7.

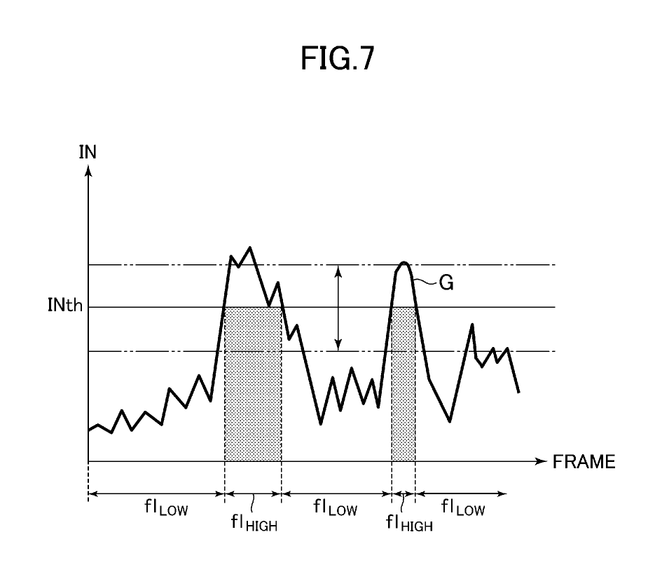

Described more specifically, a graph G showing the transition of the index IN in each frame is shown in FIG. 7. The horizontal axis indicates a frame (frame number), and the vertical axis indicates an index IN. Color Doppler image data of each frame flHIGH greater than the threshold value INth is not targeted for the maximum intensity projection. Only color Doppler image data of each frame flLOW less than the threshold value INth is targeted for the maximum intensity projection.

The threshold value INth changes upward and downward by turning the dial by the operator. As the threshold value INth is set higher, composite color Doppler image data on which color Doppler image data of more frames have been reflected is generated. In this case, however, more motion artifacts are mixed therein. On the other hand, as the threshold value INth is set lower, composite color Doppler image data from which motion artifacts have been more eliminated is generated. In this case, however, a color Doppler image becomes an image of image quality low in composite effect because the number of frames reflected on the composite color Doppler image data is reduced. The operator suppresses the motion artifacts while looking at the display unit 6 and sets the threshold value INth by turning the dial so as to be able to obtain a color Doppler image of desired image quality having even a composite effect. Thus, the operator is capable of displaying a color Doppler image of desired image quality on which color Doppler image data of as many frames as possible have been reflected, although motion artifacts are being suppressed.

Modifications of the embodiment will next be described. The first modification will first be explained. The index calculating unit 52 may calculate the index IN by integrating the value of color Doppler image data at each frame. That is, in the first modification, the index IN is the integrated value of the color Doppler image data.

The second modification will next be described. Instead of the maximum intensity projection, the combining unit 53 may additionally-average data of spatially corresponding pixels, which are color Doppler image data of plural frames in each of which the index IN is less than the threshold value INth, to thereby generate the composite color Doppler image data. That is, the composite color Doppler image data is generated using color Doppler image data of all frames in each of which the index IN satisfies a prescribed reference.

Although the invention has been described above by the embodiments, it is needless to say that the invention can be modified and implemented in various ways within the scope that does not change the gist of the invention. For example, the index calculating unit 52 may calculate the index IN, based on the color Doppler data being raw data instead of the color Doppler image data. For example, the index calculating unit 52 may integrate color Doppler data to calculate the index IN.

The combining unit 53 may combine the color Doppler data prior to being converted to color Doppler image data.

The index calculating unit 52 and the combining unit 53 may not be provided in the display controller 5.

The threshold value INth may be set in advance. Even in this case, the threshold value INth is set to a value at which a color Doppler image of image quality having even a composite effect is obtained, while suppressing motion artifacts.

Further, the processing to be performed by the echo data processor 4 in addition to the B-mode processing may be processing for obtaining data indicative of the motion of each tissue in the subject. The processing is not limited to the color Doppler processing. For example, as the processing for obtaining the data indicative of the motion of each tissue in the subject, any of power Doppler processing, B-flow processing, contrast data processing and the like, and other processing of echo signals in a mode for blood flow imaging may be performed.

The power Doppler processing includes quadrature detection processing, MTI filter (Moving Target Indication filter) processing and the like. Power Doppler data is generated by the power Doppler processing. In this case, power Doppler image data obtained by scan-converting the power Doppler data is combined with the B-mode image data so that an ultrasound image in which a power Doppler image is overlaid on a B-mode image is displayed. Power Doppler image data or power Doppler data of plural frames are combined together, and a power Doppler image based on the resultant composite data is displayed superimposed on its corresponding B-mode image. Further, the index IN is calculated based on the power Doppler image data or the power Doppler data.

The B-flow processing is processing for by a coded excitation technique, eliminating a signal given from a biological tissue remaining stationary and extracting a signal of a moving portion such as a blood flow. B-flow data is generated by the B-flow processing. In this case, B-flow image data obtained by scan-converting the B-flow data is combined with the B-mode image data so that an ultrasound image in which a B-flow image is displayed on a B-mode image is displayed. B-flow image data or B-flow data of plural frames are combined together, and a B-flow image based on the resultant composite data is displayed on its corresponding B-mode image. Further, the index IN is calculated based on the B-flow image data or the B-flow data.

In the contrast data processing, contrast data is generated by performing processing for generating a contrast image in which a contrast agent administered to the subject has been emphasized. For example, the contrast data processing is filter processing for extracting a high frequency component of an echo signal. The contrast data processing may be processing for extracting each echo signal from a contrast agent by a pulse inversion method. Alternatively, the contrast data processing may be processing (Amplitude Modulation) for subtracting echo data based on echo signals obtained by transmitting ultrasound waves different in amplitude to extract a signal component from a contrast agent.

When contrast data is generated, contrast image data in which the contrast data is scan-converted, is combined with the B-mode image data, so that an ultrasound image in which a contrast image is displayed on its corresponding B-mode image is displayed. Further, contrast image data or contrast data of plural frames are combined together, and a contrast image based on the resultant composite data is displayed on its corresponding B-mode image. The contrast image may however be displayed in parallel with the B-mode image.

Further, when contrast data is generated, the index IN is calculated based on the contrast image data or the contrast data.

Many widely different embodiments of the invention may be configured without departing from the spirit and the scope of the present invention. It should be understood that the present invention is not limited to the specific embodiments described in the specification, except as defined in the appended claims.

Embodiments of the present invention can be applied to the ultrasound image displaying apparatus which obtains the composite data combined using the data of some or all frames in each of which the index related to the amount of the motion artifacts satisfies the prescribed reference, and the apparatus can display an ultrasound image of desired image quality in terms of the motion artifacts.

1. An ultrasound image displaying apparatus comprising:
a composite data generating unit which generates composite data in which data based on echo signals obtained by transmitting ultrasound to a subject are multiple-frame combined;
a display unit on which an ultrasound age based on the composite data is displayed; and
an index calculating unit which calculates an index related to the amount of motion artifacts in the ultrasound image for each frame, based on the data,
wherein the composite data generating unit generates composite data combined using data of some or all frames in each of which the index satisfies a prescribed reference.

2. The ultrasound image displaying apparatus according to claim 1, wherein the index is calculated based on data indicative of the motion of a tissue in the subject, which is obtained based on the echo signals.

3. The ultrasound image displaying apparatus according to claim 1, including an operation unit which sets the prescribed reference through an operator.

4. The ultrasound image displaying apparatus according to claim 2, including an operation unit which sets the prescribed reference through an operator.

5. The ultrasound image displaying apparatus according to claim 2, wherein the data indicative of the motion is obtained by signal processing of the echo signals in a mode for blood flow imaging.

6. The ultrasound image displaying apparatus according to claim 5, wherein the mode for the blood flow imaging is a mode for obtaining a color Doppler image, a power Doppler image, a B-flow image or a contrast image.

7. The ultrasound image displaying apparatus according to claim 1, wherein the composite data generating unit performs composition using data of maximum values at spatially corresponding positions, of data of plural frames in each of which the index satisfies a prescribed reference to thereby generate the composite data of one frame.

8. The ultrasound image displaying apparatus according to claim 2, wherein the composite data generating unit performs composition using data of maximum values at spatially corresponding positions, of data of plural frames in each of which the index satisfies a prescribed reference to thereby generate the composite data of one frame.

9. The ultrasound image displaying apparatus according to claim 3, wherein the composite data generating unit performs composition using data of maximum values at spatially corresponding positions, of data of plural frames in each of which the index satisfies a prescribed reference to thereby generate the composite data of one frame.

10. The ultrasound image displaying apparatus according to claim 1, wherein the composite data generating unit adds and averages over plural frames, the data based on the echo signals at the spatially corresponding positions to thereby generate the composite data of one frame.

11. The ultrasound image displaying apparatus according to claim 2, wherein the composite data generating unit adds and averages over plural frames, the data based on the echo signals at the spatially corresponding positions to thereby generate the composite data of one frame.

12. The ultrasound image displaying apparatus according to claim 1, wherein in an ultrasound image generated based on the data indicative of the motion of the tissue in the subject, obtained based on the echo signals, the index is calculated based on the number of pixels in each of which the data of the motion exists.

13. The ultrasound image displaying apparatus according to claim 2, wherein in an ultrasound image generated based on the data indicative of the motion of the tissue in the subject, obtained based on the echo signals, the index is calculated based on the number of pixels in each of which the data of the motion exists.

14. The ultrasound image displaying apparatus according to claim 3, wherein in an ultrasound image generated based on the data indicative of the motion of the tissue in the subject, obtained based on the echo signals, the index is calculated based on the number of pixels in each of which the data of the motion exists.

15. The ultrasound image displaying apparatus according to claim 1, wherein the index is an integrated value of the data indicative of the motion of the tissue in the subject, obtained based on the echo signals.

16. The ultrasound image displaying apparatus according to claim 2, wherein the index is an integrated value of the data indicative of the motion of the tissue in the subject, obtained based on the echo signals.

17. The ultrasound image displaying apparatus according to claim 1, wherein the data of the plural frames are volume data obtained in a three-dimensional region of the subject.

18. The ultrasound image displaying apparatus according to claim 1, wherein the data of the plural frames are data different in time at one cross section of the subject.

19. The ultrasound image displaying apparatus according to claim 1 further comprising:
an ultrasound probe which transmits ultrasound to a subject and receives echo signals of the subject,
wherein the echo signal are processed so as to generate ultrasound image data for displaying an ultrasound image.

20. A method for displaying an ultrasound image comprising the steps of:
generating composite data in which data based on echo signals obtained by transmitting ultrasound to a subject are multiple-frame combined;
displaying an ultrasound image based on the composite data on a display unit; and
calculating an index related to the amount of motion artifacts in the ultrasound image for each frame, based on the data,
wherein the step of generating composite generates composite data combined using data of some or all frames in each of which the index satisfies a prescribed reference.
